(19) United States
(12) Patent Application Publication
(10) Pub. No.: US 2025/0364237 A1
(43) Pub. Date: Nov. 27, 2025

(54) A MULTIPOLE ROD ASSEMBLY AND A METHOD FOR MANUFACTURING ROD SUPPORTS FOR THE SAME

(71) Applicant: Micromass UK Limited, Wilmslow (GB)

(72) Inventors: David Gordon, Middlewich (GB); Mark Walford, Wilmslow (GB); David Langridge, Macclesfield (GB); Stephen Ayrton, Bradford (GB)

(73) Assignee: Micromass UK Limited, Wilmslow (GB)

(21) Appl. No.: 18/872,046

(22) PCT Filed: May 25, 2023
(86) PCT No.: PCT/GB2023/051372

§ 371 Date: Dec. 5, 2024

(30) Foreign Application Priority Data
Jun. 7, 2022 (GB) 2208308.3

(51) Int. Cl. H01J 49/42; H01J 49/06

(52) U.S. Cl. CPC H01J 49/42; H01J 49/063; H01J 49/068

(57) ABSTRACT

A method for manufacturing a multipole assembly of a mass spectrometer, the method comprising: machining a body to form an opening extending along a predetermined axis through the body, wherein the opening has a profile that defines a pair of opposed seats, each seat being configured to guide a rod of the multipole assembly, cutting the body into a plurality of pieces to form a plurality of identical rod supports, seating a first pair of rods in the seats of a first pair of the rod supports, and seating a second pair of rods in the seats of a second pair of the rod supports, wherein the second pair of rod supports are rotated relative to the first pair of rod supports.

### TECHNICAL FIELD

The present disclosure relates generally to the field of linear multipole rod assemblies for use in mass spectrometers, and more particularly to a method of manufacturing rod supports for use in such a rod assembly, and to a multipole rod assembly itself.

### BACKGROUND

Mass spectrometers comprising multipole rod assemblies are well known in the art. The multipole rod assemblies are operated to control the motion of ions and comprise a plurality of round rods (i.e. rod-shaped electrodes), which are arranged in parallel and equidistantly spaced from a center axis. The rods are provided in opposed pairs. There may, for example, be four, six or eight rods provided. Radio frequency (RF) and direct current (DC) voltages are applied to the rods, with the opposed rods carrying like voltages. Oscillating electrical fields are used to selectively stabilize or destabilize ions. Each opposing rod pair is connected electrically, and an RF alternating current voltage is applied between the rods. A DC voltage is then superimposed on the RF voltage, which causes the ions to adopt an oscillatory trajectory as they travel between the rods. Only ions with a selected m/z (mass divided by charge) value are able to achieve a stable trajectory, which allows them to reach the next stage of the mass spectrometer, for example, a detector.

It is critical that the distance between the opposed pairs of rods is as uniform as possible along the entire axial length of the rods. Errors in the parallelism of the rods along the multipole length affects the performance of the device. Rod supports are typically provided for appropriately supporting the rods with two or more of the support members spaced axially from one another along the rods.

High voltage differences between rods of opposing phase requires suitable insulators to be used. This limits the potential materials which can be used for the rod supports.

Many additional features are required to provide connectivity to each pair of rods, which increases build time and introduces opportunities for trapped volumes. In addition, it may be necessary to provide a shield rod or similar to prevent charge building up on the rod support assembly.

The combination of the issues above makes multipole assemblies difficult to manufacture consistently, leading to them being expensive, susceptible to poor yield, and providing a large variation in performance between multipole assemblies.

The present invention arose in a bid to provide an improved rod support for a multipole rod assembly, capable of ensuring high accuracy whilst also offering simplified manufacture.

### SUMMARY

According to a first aspect, there is provided a method for manufacturing a multipole assembly of a mass spectrometer, the method comprising: machining a body to form an opening extending along a predetermined axis through the body, wherein the opening has a profile that defines two or more seats, each seat being configured to guide a rod of the multipole assembly, and cutting the body into a plurality of pieces to form a plurality of identical rod supports, seating a first plurality of rods in the seats of a first pair of the rod supports, and seating a second plurality of rods in the seats of a second pair of the rod supports, wherein the second pair of rod supports are rotated relative to the first pair of rod supports.

According to a second aspect, there is provided a multipole assembly of a mass spectrometer comprising a plurality of identical rod supports and a plurality of rods supported thereby, wherein each of the rod supports comprises an opening extending along a predetermined axis through the body, wherein the opening has a profile that defines two or more seats, wherein a first plurality of the rods is seated in the seats of a first pair of the rod supports, the first pair of the rod supports being spaced from one another in a length direction of the rods, wherein a second plurality of the rods is seated in the seats of a second pair of the rod supports, the second pair of the rod supports being spaced from one another in a length direction of the rods, and wherein the second pair of rod supports are rotated relative to the first pair of rod supports.

According to a third aspect, there is provided a multipole assembly of a mass spectrometer comprising a plurality of rod supports and a plurality of rods supported thereby, wherein each of the rod supports comprises an opening extending along a predetermined axis through the body, which has a profile that defines a two or more seats, wherein each of the rods is seated in the seats of some but not all of the plurality of rod supports, and wherein each of the rods has a field nulling element fixed thereto at each point along its length where it passes through an opening in one of the rod supports without being seated in one of the seats thereof.

The multipole assembly is preferably a quadrupole, wherein each of the supports comprises a pair of opposed seats and the second pair of rod supports are rotated relative to the first pair of rod supports by 90 degrees.

The features of the above aspects may be combined in any combination.

The rod supports are preferably metal.

The field nulling elements are preferably metal.

The field nulling elements preferably have substantially the same thickness, in an axial direction of the rods, as the supports, and are aligned with the supports in the axial direction.

There may be a constant gap provided between an outer surface of each field nulling element and an inner surface of the opening. The outer face of each field nulling element may be configured to match the profile of the opening.

Further, preferable, features are presented in the dependent claims.

These and other aspects and features of the present disclosure will be more readily understood when read in conjunction with the accompanying drawings. Moreover, it must be noted that the various features of any of the above statements may be combined without restriction, as will be readily appreciated by those skilled in the art.

### BRIEF DESCRIPTION OF THE DRAWINGS

FIG. 1 is a perspective view of a machined body for use in forming four identical rod supports;

FIG. 2 is a perspective view of a rod support formed by cutting the body of FIG. 1;

FIG. 3 is plan view of the rod support of FIG. 2;

FIG. 4 is a perspective view of a quadrupole rod assembly comprising four identical rod supports formed by cutting the body of FIG. 1;

FIG. 5 is a perspective view of a field nulling element from the rod assembly of FIG. 4; and

FIG. 6 is an end view of the rod assembly of FIG. 4.

### DETAILED DESCRIPTION

It should be appreciated that whilst much of the discussion herein will focus on a quadrupole arrangement, the present invention is not to be limited thereto. The different aspects of the present invention may, for example, be applied, in isolation or in combination, to multipole rod assemblies that comprise six or eight rods, to rod supports therefor, and/or to their manufacture.

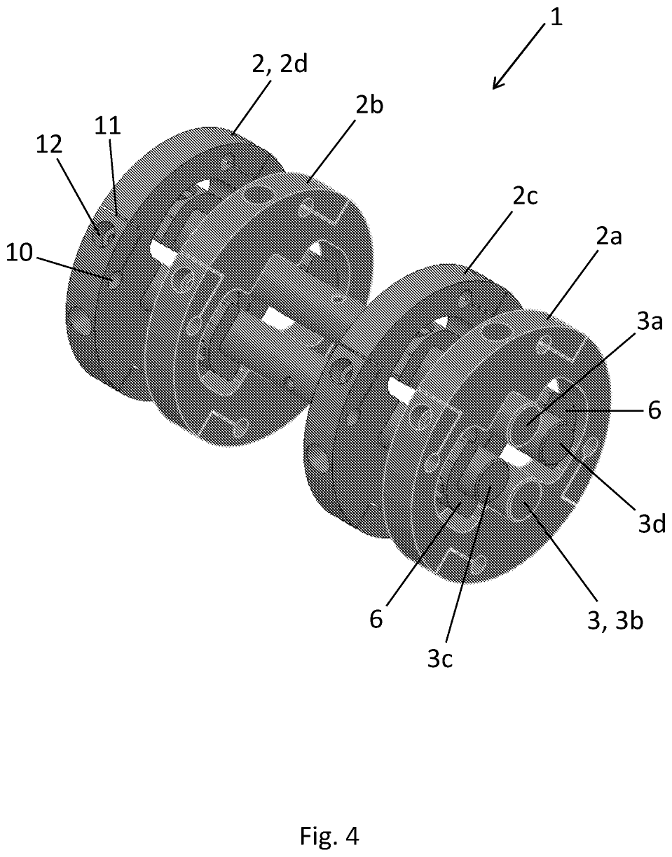

With reference to FIG. 4, there is shown a multipole rod assembly 1 for a mass spectrometer. The rod assembly comprises a plurality of rod supports 2 which are spaced apart from one another along the length of the rods 3 that are supported thereby. Each of the rod supports 2 comprises an opening 4 through the body of the rod support 2. The opening 4 has a profile that defines a pair of opposed seats 5.

According to one aspect, the rod supports 2 are identical to one another. A first pair of the rods 3a, 3b is seated in the seats 5 of a first pair of the rod supports 2a, 2b. A second pair of the rods 3c, 3d is seated in the seats of a second pair of the rod supports 2c, 2d. The second pair of rod supports 2c, 2d are rotated relative to the first pair of rod supports 2a, 2b.

In the present quadrupole arrangement, the second pair of rod supports 2c, 2d are rotated relative to the first pair of rod supports 2a, 2b by 90 degrees.

In alternative arrangements comprising more rods, there may be additional pairs of rod supports provided at intervening angles of rotation relative to the first and second pairs of rod supports. Moreover, it may be that none of the rod supports are rotated at 90 degrees relative to one another.

In yet further arrangements comprising more rods, there may be additional seats provided per rod support, regardless of whether there are four or more rod supports provided.

For example, with a hexapole arrangement, there could be three seats provided per rod support, with two pairs of rod supports provided, and an appropriate angular rotation, which would not be 90 degrees, between the pairs of rod supports. Alternatively, for a hexapole arrangement, there could be two seats per rod support but three pairs of rod supports provided, with an appropriate angular rotation between each of the pairs of rod supports.

Various alternatives to suit any desired number of rods will be readily appreciated by those skilled in the art. The present invention is not limited to any particular number of rods.

According to another aspect, each the rods 3 is seated in the seats 5 of some but not all of the plurality of rod supports 2, and each of the rods 3 has a field nulling element 6 fixed thereto at each point along its length where it passes through an opening 4 in one of the rod supports 2 without being seated in one of the seats 5 thereof.

As is clear, in the arrangement of FIG. 4, the two described aspects are combined. In alternative arrangements this need not be the case, for example, the nulling elements 6 may be provided in a rod assembly that comprises rod supports 2 that are not identical to one another. Numerous alternative arrangements will be readily appreciated by those skilled in the art.

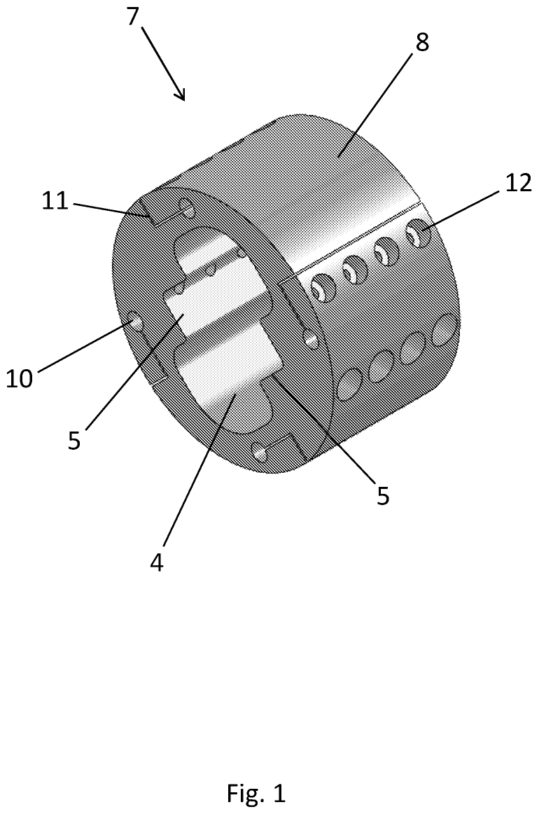

The rod supports 2 are preferably manufactured by the method discussed below with reference to FIGS. 1 to 3, however, it should be appreciated that they may be produced otherwise.

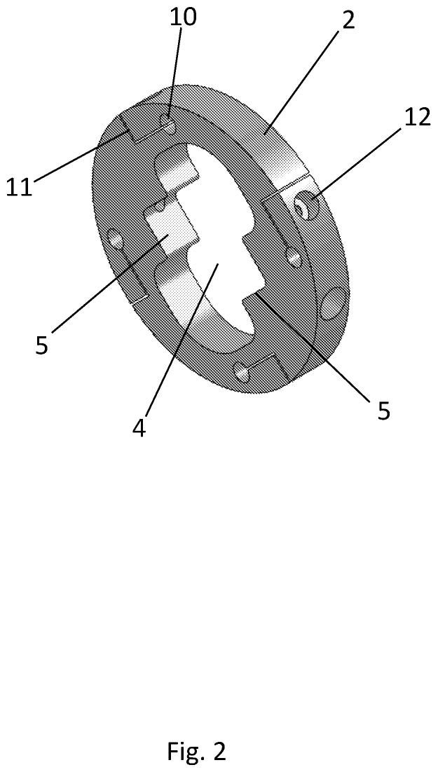

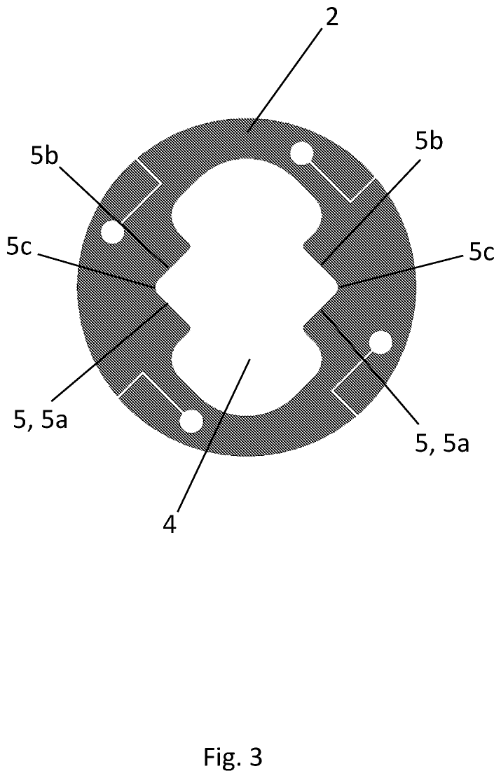

FIG. 1 shows a machined body 7 for use in forming a plurality of identical rod supports 2. FIGS. 2 and 3 show a rod support 2 formed by cutting the body 7 of FIG. 1. The method for manufacturing rod supports for a multipole assembly of a mass spectrometer comprises machining the body 7 to form an opening 4 extending along a predetermined axis through the body. The opening 4 has a profile that defines a pair of opposed seats 5. Each of the seats 5 is configured to guide a rod 3 of the multipole assembly. Once formed, the body 7 is cut into a plurality of pieces (or slices) to form a plurality of identical rod supports 2.

The body 7 is cut into four identical pieces to form the rod supports 2a, 2b, 2c, 2d for the quadrupole rod assembly of FIG. 4. For forming rod supports 2 for multipole rod assemblies comprising more than four rod supports, the body, and its opening, will be appropriately formed, and the body will be cut into the appropriate number of pieces (or slices).

With identical rod supports, which are formed from a common body, variations between rod supports 2, and errors in parallelism, are minimised.

The body 7 is preferably formed by machining a unitary body of conductive material. The material is most preferably metal.

The body preferably has a substantially cylindrical outer face 8, as shown. It need not be limited as such, however. In alternative arrangements, the outer profile may take various different forms, for example it could have straight outer faces or comprise a combination of straight and curved faces.

At least the seats 5 are preferably formed by electrical discharge machining (EDM) of the body 7. The EDM process is a multi-pass process which can be used to create parts with specific regions of high accuracy. The seats 5 can be made with extremely small variation down the length of the part. Other regions which are less critical can be omitted from later passes of the EDM process to save time and cost.

The form of the seats 5 need not be limited, however, it is preferable that each of the seats has a profile for contacting a respective rod at only two tangential points.

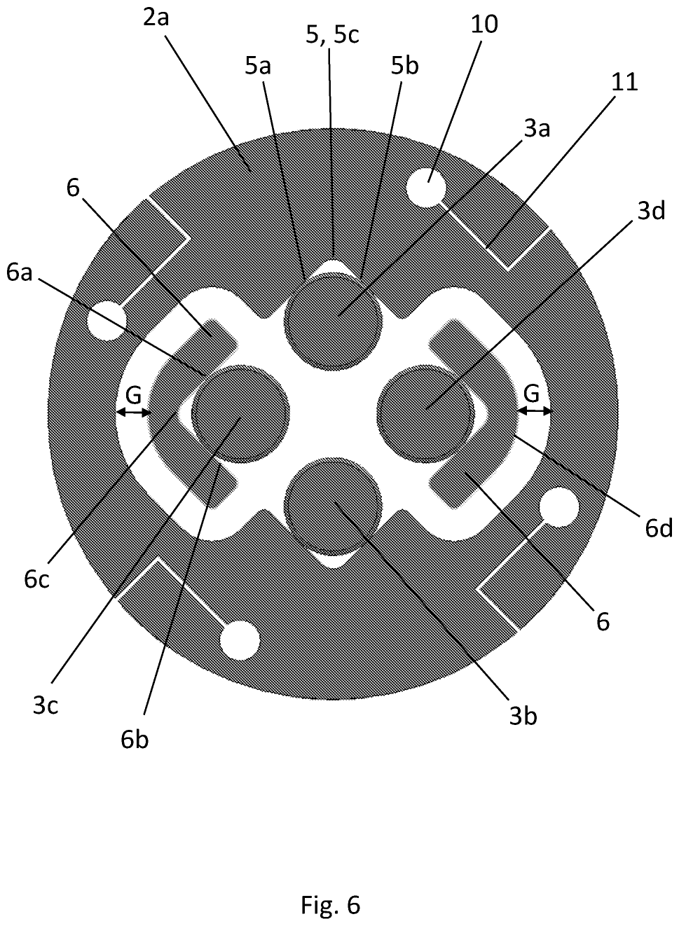

Each seat 5 preferably comprises a pair of rod contact surfaces 5a, 5b, which are straight and arranged at an angle to one another. In the present arrangement, the rod contact surfaces 5a, 5b are arranged at an angle of substantially 90 degrees to one another, as shown in FIGS. 3 and 6. It should be appreciated that in alternative arrangements, this angle may change. The rod contact surfaces are preferably spaced from one another, as best seen in FIGS. 3 and 6. In the present arrangement, as is preferred, the spaced rod contact surfaces are joined to one another by an intermediate curved surface 5c. By such arrangement, the seats are substantially V-shaped. The depicted arrangement offers a form that is ideally suited to precision machining. In alternative arrangements, the rod contact surfaces could be joined directly, wherein with straight rod contact surfaces, they will meet at a vertex. Irrespective of form, each seat will be arranged to suit a particular rod diameter. Each of the seats 5 is preferably arranged to define a predetermined gap between the rod guided/received thereby and the seat at a centre point between the two tangential points, as indicated in FIG. 6. Each seat 5 may be configured to define an opening behind the rod guided thereby, with the area of the opening above a predetermined minimum to ensure suitable pressure equalization in the assembly.

Retuning to FIG. 4, it is preferable that the rod supports 2a, 2b of the first pair of rod supports and the rod supports 2c, 2d of the second pair of rod supports are alternated with one another in a length direction of the rods 2, as shown. This need not be the case in alternative arrangements, for example, the first pair of rod supports 2a, 2b could be provided between the rod supports of the second pair of rod supports 2c, 2d.

In the present arrangement, two of the rods 3a, 3b are held using the first pair of rod supports 2a, 2b and two of rods 3c, 3d are held using the second pair of rods supports 2c, 2d.

Holding the rods 3 in place using conductive rod supports 2 can cause problems with the field within the multipole rod assembly due to field penetration through the gaps between the rods. Even if each of the rod supports is designed to leave significant gaps between itself and the gaps between the rods, the performance can be affected. To overcome this, it is possible to add a field nulling element 6 to each of the opposing rods (i.e. the rods of the opposite phase to the rod support, which rods are not seated in the seats of that rod support) to effectively balance out the field and significantly reduce the field penetration.

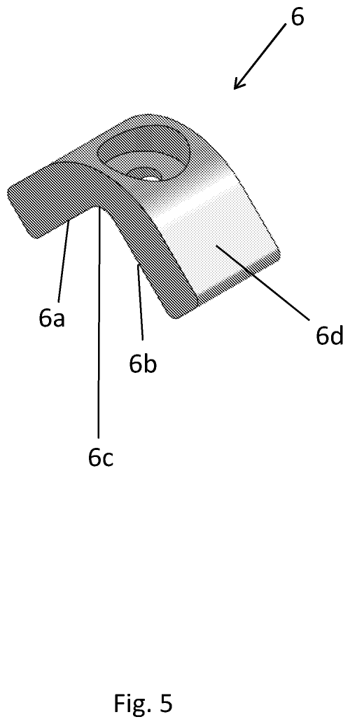

FIG. 5 shows an exemplary field nulling element 6. FIGS. 4 and 6 show the field nulling elements 6 in situ.

The field nulling elements 6 preferably have the same thickness, in an axial direction of the rods, as the supports 2, and are aligned with the supports 2 in the axial direction, as best seen in FIG. 4. By such arrangement they are present over the same distance as the rod supports 2. Within the opening 4 of each rod support an opposed pair of the field nulling elements 6 are provided, as seen in FIGS. 4 and 6.

The field nulling elements 6 are preferably formed from a conductive material, most preferably metal.

The field nulling elements 6 are preferably attached to the rods 3 using screws or similar fasteners.

The field nulling elements 6 may be substantially V-shaped, as shown. They may, however, take alternative forms.

Each field nulling element 6 may comprise a pair of rod contact surfaces 6a, 6b, which are straight and arranged at an angle to one another. In the present arrangement, the rod contact surfaces are arranged at substantially 90 degrees to one another, as shown in FIGS. 3 and 6. By such an arrangement, a substantially square profile is defined by the combination of the rod contact surfaces of the field nulling elements and the rod contact surfaces of the seats, as seen in FIG. 6. It should be appreciated that in alternative arrangements, this angle may be other than 90 degrees. The rod contact surfaces of the field nulling elements are preferably spaced from one another, as best seen in FIGS. 3 and 6. In the present arrangement, as is preferred, the spaced rod contact surfaces are joined to one another by an intermediate curved surface 6c. By such arrangement, the rod contact surfaces define a V-shape. In alternative arrangements, the rod contact surfaces of the filed nulling elements could be joined directly, wherein with straight rod contact surfaces, they will meet at a vertex.

There may be a constant gap G provided between an outer surface 6d of each field nulling element 6 and an inner surface of the opening 4, as shown in FIG. 6. The outer face 6d of each field nulling element may be configured to match the profile of the opening, as seen in FIG. 6.

With reference again to FIG. 1, the body 7 preferably further comprises a plurality of through holes 10, which have their axes parallel to the axis of the opening 4, and which are arranged outside a periphery of the opening. In the present arrangement there are four of the holes 10 provided. In alternative arrangements there may be more or less of the holes 10 provided.

Each of the holes 10 is preferably associated with a respective slot 11, which extends between the hole 10 and the outer face 8 of the body 7. The slots 11 extend for the length of the body 7 as shown. Each slot 11 is preferably substantially L-shaped with a first portion extending radially out from the hole 10 and a second portion extending from the end of the first portion, at an angle of 90 degrees relative to the first portion, out to the outer face 8. The slot by such arrangement in co-operation with a screw (not shown) to be received in an appropriate threaded hole 12, defines a clamp.

The holes 10 are arranged such that once the body 7 is cut to form the rod supports 2 and the rod supports 2 are installed in the multipole rod assembly 1 to support the rods 3 in the seats 5 thereof, as discussed above and exemplarily shown in FIG. 4, the holes 10 of adjacent rod supports 2 are aligned with one another. The holes 10 may receive ceramic bars that pass through adjacent rod supports. Most preferably each of the holes 10 of each of the rod supports 2 aligns with a corresponding hole 10 in each of the other rod supports 2 in the assembly. In such case the ceramic bars received by the holes 10 may extend for substantially the same length as the rods, and be supported by all of the rod supports 2 in the assembly in the holes 10.

The holes 10 are shown to be round, however, they may take any alternative shape. They are preferably shaped to match the profile of the ceramic bars to be received thereby.

By the provision of the clamps, as discussed above, the ceramic bars may be gripped to prevent movement. However, in alternative arrangements, the slits 11 may be omitted with alternative fixing means provided for the ceramic bars, such as screws that are arranged radially to the holes 10 and which penetrate the holes to thereby grip the ceramic bars.

It should, moreover, be appreciated that the holes 10 and ceramic bars may be omitted altogether in alternative arrangements.

One or more of the embodiments as discussed herein may offer one or more or all of the following benefits:
Alignment
   Parallelism is improved
Charging
   When the rod supports are metallic they are less prone to charging than ceramic (and screen/earthing rods not required)
   Fewer trapped volumes due to fewer connections
Noise
   RF breakdown less likely due to possible better controlled wiring
   Lower electron emission from ceramic surfaces
Thermal Effects
   Thermal coefficients of expansion can be matched to minimize drift with temperature
Build
   Quicker to build due to fewer components
   Connectivity provided by rod supports

Therefore, the disclosed rod supports, and method of manufacture, are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Although various example embodiments have been disclosed, a worker of ordinary skill in this art would recognize that certain modifications would come within the scope of this disclosure. For that reason, the following claims should be studied to determine the scope and content of this disclosure.

1. A method for manufacturing a multipole assembly of a mass spectrometer, the method comprising:
machining a body to form an opening extending along a predetermined axis through the body, wherein the opening has a profile that defines two or more seats, each seat being configured to guide a rod of the multipole assembly,
cutting the body into a plurality of pieces to form a plurality of identical rod supports,
seating a first plurality of rods in the seats of a first pair of the rod supports, and seating a second plurality of rods in the seats of a second pair of the rod supports, wherein the second pair of rod supports are rotated relative to the first pair of rod supports.

2. A method as claimed in claim 1, wherein the body has a substantially cylindrical outer face.

3. A method as claimed in claim 1, wherein at least the seats are formed by electrical discharge machining of the body.

4. A method as claimed in claim 1, wherein each of the seats has a profile for contacting the rod at only two tangential points.

5. A method as claimed in claim 4, wherein each seat comprises a pair of rod contact surfaces, which are straight and arranged at an angle to one another.

6. A method as claimed in claim 5, wherein the rod contact surfaces are arranged at substantially 90 degrees to one another.

7. (canceled)

8. (canceled)

9. A rod support as claimed in claim 1, wherein the seats are substantially V-shaped.

10. A method as claimed in claim 1, wherein the body is metal.

11. A method as claimed in claim 1, wherein the body is cut into four identical pieces to form four identical rod supports.

12. A method as claimed in claim 1, wherein the multipole assembly comprises a quadrupole assembly, wherein each rod support comprises a pair of opposed seats, and the second pair of rod supports are rotated through 90 degrees relative to the first pair of rod supports.

13. A method as claimed in claim 1, wherein the rod supports of the first pair of rod supports and the rod supports of the second pair of rod supports are alternated with one another in a length direction of the rods.

14. A multipole assembly of a mass spectrometer comprising a plurality of identical rod supports and a plurality of rods supported thereby,
wherein each of the rod supports comprises an opening extending along a predetermined axis through the body, wherein the opening has a profile that defines two or more seats,
wherein a first plurality of the rods is seated in the seats of a first pair of the rod supports, the first pair of the rod supports being spaced from one another in a length direction of the rods,
wherein a second plurality of the rods is seated in the seats of a second pair of the rod supports, the second pair of the rod supports being spaced from one another in a length direction of the rods, and
wherein the second pair of rod supports are rotated relative to the first pair of rod supports.

15. A multipole assembly as claimed in claim 14, wherein the rod supports of the first pair of rod supports and the rod supports of the second pair of rod supports are alternated with one another in a length direction of the rods.

16. A multipole assembly as claimed in claim 14, wherein each of the seats has a profile for contacting the rod at only two tangential points.

17. A multipole assembly as claimed in claim 16, wherein each seat comprises a pair of rod contact surfaces, which are straight and arranged at an angle to one another.

18. (canceled)

19. (canceled)

20. (canceled)

21. A multipole assembly as claimed in claim 14, wherein the seats are substantially V-shaped.

22. A multipole assembly as claimed in claim 14, wherein the rod supports are metal.

23. A multipole assembly as claimed in claim 14, wherein each of the rods has a field nulling element fixed thereto at each point along its length where it passes through an opening in one of the rod supports without being seated in one of the seats.

24. A multipole assembly as claimed in claim 23, wherein a constant gap is provided between an outer surface of each field nulling element and an inner surface of the opening.

25. A multipole assembly as claimed in claim 23, wherein the field nulling elements have the same thickness, in an axial direction of the rods, as the supports, and are aligned with the supports in the axial direction.
